(19) United States
(12) Patent Application Publication
(10) Pub. No.: US 2014/0304381 A1
(43) Pub. Date: Oct. 9, 2014

(54) METHOD AND APPARATUS FOR COMMUNICATING WITH SMART OBJECTS

(71) Applicant: Nokia Corporation, Espoo (FI)

(72) Inventors: Teemu Ilmari Savolainen, Nokia (FI); Jukka Pekka Reunamaki, Tampere (FI); Bilhanan Silverajan, Kangasala (FI)

(73) Assignee: Nokia Corporation, Espoo (FI)

(21) Appl. No.: 14/245,347

(22) Filed: Apr. 4, 2014

Related U.S. Application Data
(60) Provisional application No. 61/808,732, filed on Apr. 5, 2013.

(51) Int. Cl. H04L 12/24; H04L 29/12

(52) U.S. Cl. CPC H04L 41/0806; H04L 61/6018
USPC 709/222

(57) ABSTRACT

A method, apparatus, and computer program product are disclosed to communicate with a smart object. In the context of a method, an identifier associated with a smart object is received. The method includes causing transmission of the identifier, receiving, based on the identifier, one or more universal resource identifiers (URIs) associated with the smart object, and selecting, by a processor, one of the URIs for communication between a device and the smart object. A corresponding apparatus and computer program product are also provided.

### TECHNOLOGICAL FIELD

Example embodiments of the present invention relate generally to smart objects and, more particularly, to a method and apparatus for discovering universal resource identifiers (URIs) associated with smart objects and for communicating with smart objects.

### BACKGROUND

The “Internet of Things” is a quickly growing industry, and some estimates suggest that by 2020 there will be 50 billion Internet connected devices (smart objects). To maximize their utility, smart objects need Internet connectivity and also other configuration information. Furthermore, mobile handsets should be able to find and efficiently access these smart objects. However, new smart objects often are not preconfigured. In this regard, such smart objects lack configuration specifying how to connect to the Internet, where to send data, and often do not yet indicate their ownership status. Given the growing ubiquity of smart objects, when a user purchases a new smart object, he or she will want this relevant information configured as easily as possible (and only he or she or their device knows the info).

Accordingly, to properly use their smart objects, users need to know what smart objects are reachable and discoverable. Furthermore, users (or rather their devices) need to be provided with information about WHAT and HOW to configure and control newly found smart objects. The information about WHAT and HOW is not currently available unless it is hardcoded in the smart object. This is especially problematic at this stage of Internet of Things world, as standards and best practices are just forming. Moreover, once smart objects are configured and operational, they need to be accessed efficiently and by using the most appropriate transport channels.

### BRIEF SUMMARY

Accordingly, a method, apparatus, and computer program product are provided for finding smart objects that need configuration, getting configuration information from the cloud to a client device, and for selecting the best transport channel for accessing and using the smart objects.

In a first example embodiment, a method is provided that includes retrieving an identifier associated with a smart object and causing transmission of the identifier. The method further includes receiving, based on the identifier, one or more URIs associated with the smart object and selecting, by a processor, one of the URIs for communication between a device and the smart object.

In some embodiments, the method may scan for the identifier using at least one method selected from the group consisting of wireless local area network (WLAN) scanning, Bluetooth scanning, Internet Protocol version 4 (IPv4)-based scanning, Internet Protocol version 6 (IPv6)-based scanning, AwareNet scanning, Short Message Service (SMS)-based discovery, Near-Field Communication (NFC) tag reading, Quick Response (QR) code reading, or barcode reading, wherein the identifier is retrieved in response to the scan. In one such embodiment, the method may include receiving information identifying a location or scanning method, wherein scanning for the identifier is performed at the identified location or using the identified scanning method. Scanning for the identifier may be performed automatically or alternatively may be performed in response to user input.

In another embodiment, the method includes obtaining additional information about the device and the smart object, the information comprising locations of the device and the smart object or connectivity capabilities of the device and the smart object, and prioritizing transport channels associated with the URIs based on the additional information, wherein the selected URI comprises the URI associated with the transport channel having the highest priority. The method may cause configuration of the smart object based on the selected URI.

In another example embodiment, an apparatus is provided having at least one processor and at least one memory including computer program code, the at least one memory and the computer program code configured to, with the at least one processor, cause the apparatus to retrieve an identifier associated with a smart object and cause transmission of the identifier. The at least one memory and the computer program code are further configured to, with the at least one processor, cause the apparatus to receive, based on the identifier, one or more URIs associated with the smart object and select one of the URIs for communication between a device and the smart object.

In some embodiments, the at least one memory and the computer program code are further configured to, with the at least one processor, cause the apparatus to scan for the identifier using at least one method selected from the group consisting of WLAN scanning, Bluetooth scanning, IPv4-based scanning, IPv6-based scanning, AwareNet scanning, SMS-based discovery, NFC tag reading, QR code reading, or barcode reading, wherein the identifier is retrieved in response to the scan. In one such embodiment, the at least one memory and the computer program code are further configured to, with the at least one processor, cause the apparatus to receive information identifying a location or scanning method, wherein scanning for the identifier is performed at the identified location or using the identified scanning method. Scanning for the identifier may be performed automatically or alternatively may be performed in response to user input.

In another embodiment, the at least one memory and the computer program code are further configured to, with the at least one processor, cause the apparatus to obtain additional information about the device and the smart object, the information comprising locations of the device and the smart object or connectivity capabilities of the device and the smart object, and prioritize transport channels associated with the URIs based on the additional information, wherein the selected URI comprises the URI associated with the transport channel having the highest priority. The at least one memory and the computer program code are further configured to, with the at least one processor, cause the apparatus to cause configuration of the smart object based on the selected URI.

In another example embodiment, a computer program product is provided that includes at least one non-transitory computer-readable storage medium having computer-executable program code portions stored therein with the computer-executable program code portions comprising program code instructions that, when executed, cause an apparatus to retrieve an identifier associated with a smart object and cause transmission of the identifier. The program code instructions, when executed, further cause the apparatus to receive, based on the identifier, one or more URIs associated with the smart object and select one of the URIs for communication between a device and the smart object.

In some embodiments, the program code instructions, when executed, further cause the apparatus to scan for the identifier using at least one method selected from the group consisting of WLAN scanning, Bluetooth scanning, IPv4-based scanning, IPv6-based scanning, AwareNet scanning, SMS-based discovery, NFC tag reading, QR code reading, or barcode reading, wherein the identifier is retrieved in response to the scan. In one such embodiment, the program code instructions, when executed, further cause the apparatus to receive information identifying a location or scanning method, wherein scanning for the identifier is performed at the identified location or using the identified scanning method. Scanning for the identifier may be performed automatically or alternatively may be performed in response to user input.

In another embodiment, the program code instructions, when executed, further cause the apparatus to obtain additional information about the device and the smart object, the information comprising locations of the device and the smart object or connectivity capabilities of the device and the smart object, and prioritize transport channels associated with the URIs based on the additional information, wherein the selected URI comprises the URI associated with the transport channel having the highest priority. The program code instructions, when executed, further cause the apparatus to cause configuration of the smart object based on the selected URI.

In another example embodiment, an apparatus is provided that includes means for retrieving an identifier associated with a smart object and causing transmission of the identifier. The apparatus further includes means for receiving, based on the identifier, one or more URIs associated with the smart object and means for selecting one of the URIs for communication between a device and the smart object.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 shows a block diagram of an apparatus that may be specifically configured in accordance with an example embodiment of the present invention;

FIG. 2 illustrates a flowchart describing example operations for communicating with a smart object, in accordance with some example embodiments;

FIG. 3a illustrates a flowchart describing example operations for retrieving an identifier associated with a smart object at an identified location, in accordance with some example embodiments;

FIG. 3b illustrates a flowchart describing example operations for using a specific scanning method to retrieve an identifier associated with a smart object, in accordance with some example embodiments;

FIG. 4a illustrates a flowchart describing example operations for selecting a URI based on location information of a device and a smart object, in accordance with some example embodiments;

FIG. 4b illustrates a flowchart describing example operations selecting a URI based on connectivity capability information of a device and a smart object, in accordance with some example embodiments;

FIGS. 5a-5d illustrate example user interfaces that may be presented to a user in accordance with some example embodiments;

FIG. 6 illustrates example operations for configuring a smart object, in accordance with some example embodiments; and

FIG. 7 illustrates example operations for obtaining information about the location of one or more smart objects from an Internet-connected server, in accordance with some example embodiments.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention.

Additionally, as used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus, and computer program product are provided in accordance with an example embodiment of the present invention in order to communicate with a smart object. As such, the method, apparatus, and computer program product may be embodied by any of a variety of devices. For example, the devices may include any of a variety of mobile terminals, such as a portable digital assistant (PDA), mobile telephone, smartphone, mobile television, gaming device, laptop computer, camera, tablet computer, video recorder, or any combination of the aforementioned devices. Additionally or alternatively, the computing device may include fixed computing devices, such as a personal computer or a computer workstation. Still further, the method, apparatus, and computer program product of an example embodiment may be embodied by a networked device, such as a server or other network entity, configured to communicate with one or more devices, such as one or more client devices.

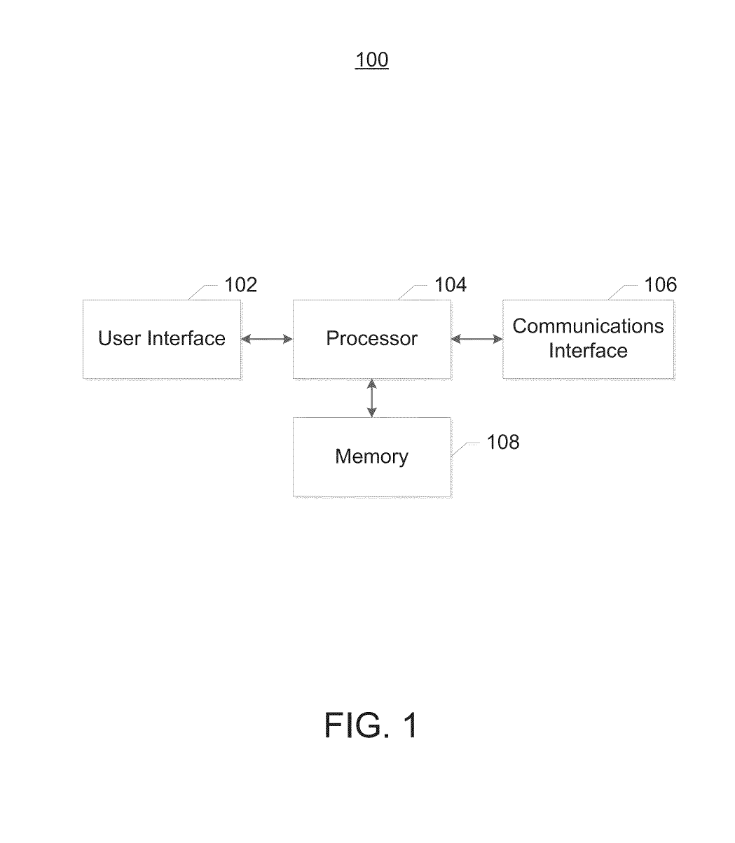

Regardless of the type of device, an apparatus 100 that may be specifically configured to communicate with and configure a smart object in accordance with an example embodiment of the present invention is illustrated in FIG. 1. It should be noted that while FIG. 1 illustrates one example configuration, numerous other configurations may also be used to implement embodiments of the present invention. As such, in some embodiments, although elements are shown as being in communication with each other, hereinafter such elements should be considered to be capable of being embodied within the same device or within separate devices.

Referring now to FIG. 1, the apparatus 100 may include or otherwise be in communication with a processor 104, a memory device 108, and optionally a communication interface 106 and a user interface 102. In some embodiments, the processor (and/or co-processor or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like, for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 100 may be embodied by a computing device, such as a computer terminal. However, in some embodiments, the apparatus may be embodied as a chip or chip set. In other words, the apparatus may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 104 may be embodied in a number of different ways. For example, the processor may be embodied as one or more of various hardware processing means such as a co-processor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

In an example embodiment, the processor 104 may be configured to execute instructions stored in the memory device 108 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU), and logic gates configured to support operation of the processor.

Meanwhile, the communication interface 106 may be any means such as a device or circuitry embodied in either hardware or a combination of hardware and software that is configured to receive and/or transmit data from/to a network and/or any other device or module in communication with the apparatus 100. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may additionally or alternatively support wired communication. As such, for example, the communication interface may include a communication modem and/or other hardware/software for supporting communication via cable, digital subscriber line (DSL), universal serial bus (USB), or other mechanisms.

In some embodiments, the apparatus 100 may include a user interface 102 that may, in turn, be in communication with processor 104 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone, and/or the like. The processor and/or user interface circuitry comprising the processor may be configured to control one or more functions of one or more user interface elements through computer program instructions (e.g., software and/or firmware) stored on a memory accessible to the processor (e.g., memory device 108, and/or the like).

Smart objects often communicate using constrained application protocol (CoAP), which is an application layer protocol for use in resource-constrained internet devices. To ensure the ability to communicate with a smart object, a device must be able to use a CoAP URI corresponding to the smart object. Some example formats of a CoAP transport URI are the following:

“coap+transport:″ ″//″ identifier path-abempty [ ″?″ query ]
coap:[options]http:[//host[:[port][transport]]/
″coap:″ ″//″ host [ ″:″ port ] path-abempty [ ″?″ query ] [ transport ]

The smart object may have multiple URIs associated with the variety of transport channels via which it is able to communicate. Different transport channels may be preferred for communication under different conditions, and different devices may not be able to communicate using every possible transport channel. Accordingly, selecting an appropriate URI to communicate with the smart object enables efficient communication with the smart object. In this regard, it is important to obtain as complete list of CoAP URIs associated with the smart object as possible. A first way to obtain a list of CoAP URIs associated with a smart object is for a device (e.g. apparatus 100) reads a smart object identifier and provide the identifier to a server, after which the server returns information related to associated identifiers (including the list of CoAP URIs over which the smart objects can be reached).

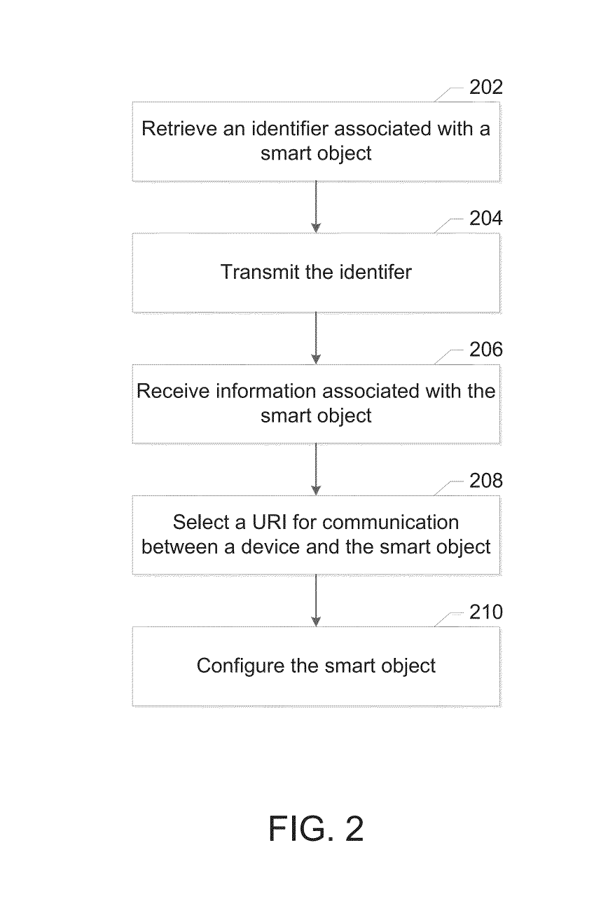

FIG. 2 illustrates a flowchart containing a series of operations performed to receive and select a URI for communication with a smart object. The operations illustrated in FIG. 2 may, for example, be performed by, with the assistance of, and/or under the control of one or more of processor 104, memory 108, user interface 102, or communications interface 106.

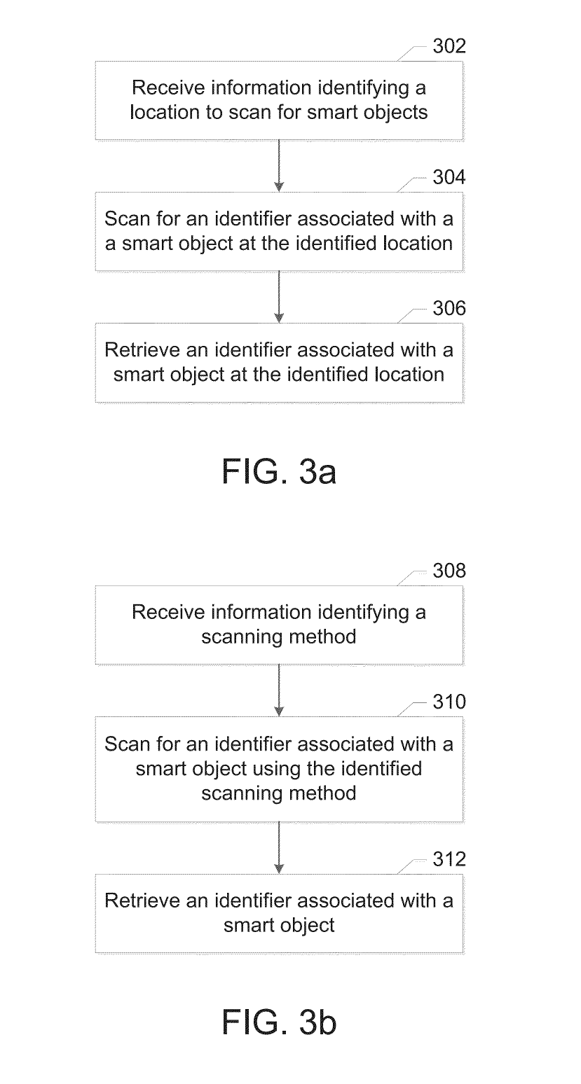

Specifically, in operation 202, apparatus 100 includes means, such as user interface 102, processor 104, the communications interface 106, memory 108, or the like, for retrieving an identifier associated with a smart object. The identifier could be, for example, a Media Access Control (MAC) address or a Fully Qualified Domain Name (FQDN). Other alternative identifiers are Internet Protocol version 4 (IPv4) addresses, Internet Protocol version 6 (IPv6) addresses, or other similar device identifiers. The identifier can be found, for example using any number of scanning technologies, such as WLAN scans (for access points, ad-hoc WLAN, Wi-Fi Direct), Bluetooth (Low-Energy) scans, IPv6-based scans on a local area networks (such as discovering device sending/listening of (multicast) CoAP resource discovery/local CoAP Resource Directory queries/multicast-Domain Name System (DNS)/Universal Plug and Play (UPnP)/some other IP-based device discovery protocol messages to LAN), AwareNet scans, SMS-based discovery (client would send SMS asking for devices nearby), NFC tag reading, or QR or other barcode reading (in which the QR code or barcode can be part of an active display, such as made with e-ink, in order to allow modification of the QR-code when needed). In some embodiments, scanning for the identifier is performed automatically. In other embodiments, scanning for the identifier is performed in response to user input, such as a user pressing a “scan” button, or by entering into a specific geographical area (identified by the user or by a geolocation service). Additional scanning embodiments are described below in conjunction with FIGS. 3a and 3b.

Subsequently, in operation 204, apparatus 100 includes means, such as communications interface 106 or the like, for transmitting the identifier. In this regard, the identifier may be transmitted to a server, such as a DNS server (if URIs are in the global DNS), a CoAP Resource Directory, or some other similar server.

In operation 206, the apparatus 100 may include means, such as processor 104 or the like, for receiving information about the smart object, the information including one or more URIs associated with the smart object. The received information about the smart object may also include information related to the smart object identifier (e.g. the MAC addresses, configuration parameters, semantics information) provided by smart object manufacturers, or contributed by a community or by smart object owners. In some embodiments, the information may be received in response to transmittal of the identifier in operation 204. However, in other embodiments, the information may be received by directly scanning the smart object itself (e.g., scanning a QR-code or NFC tag), in which case involvement of a server may not be necessary. In yet other embodiments, the information may be received from a web page, from a friend (e.g., via a social networking application), using software objects from a database, etc.

The information includes at least a list of CoAP URIs associated with transport protocols that are currently supported by the smart object and related endpoint identifiers (FQDNs, phone numbers, MAC-addresses, and so forth). The information may also include, for example, a photo of the smart object, access credentials for the smart object or for a class of smart objects (e.g., if information needs to be pushed via Bluetooth, SMS or ad-hoc WLAN network that an unconfigured smart object is using while waiting for configuration), semantics of configuration messages for the particular smart object (the information about smart object's representational state transfer (REST) interface), IPv6 addresses/ports needed for smart object configuration, and so forth. In some embodiments, this information may be received from the smart object itself as part of a discovery operation (while in a WLAN scan retrieval of this information in a discovery operation is not possible, in an IP-level scan, images and such information can be retrieved). Additionally or alternatively, the apparatus 100 may be able to read some configuration information via a CoAP GET request to well-known URI (“/.well-known/core”), although such a request could not retrieve all relevant information, such as a picture/icon of the smart object.

In some embodiments, the information may (referring now to draft-ipso-app-framework) include namespaces that the smart object supports, types of information that the smart object supports, and possibly even specific URLs that the smart object can support. The information may also include relevant default values, value ranges, settings that users must set/see, and so forth that in general will help the apparatus 100 dynamically construct a user interface (UI) control view for the smart object. In this regard, the apparatus 100 may includes means, such as user interface 102, processor 104, or the like, for displaying to the user a UI to show some or all of the information received (and which in some cases is automatically used) for checking/altering configuration settings of the smart object. If the user is happy with the settings, the apparatus 100 further includes means, such as processor 104, or the like, for pushing the settings to the smart object and, in embodiments in which the information is received from a server, also to the server (e.g., for providing updates regarding smart object ownership changes or the addition of CoAP URIs).

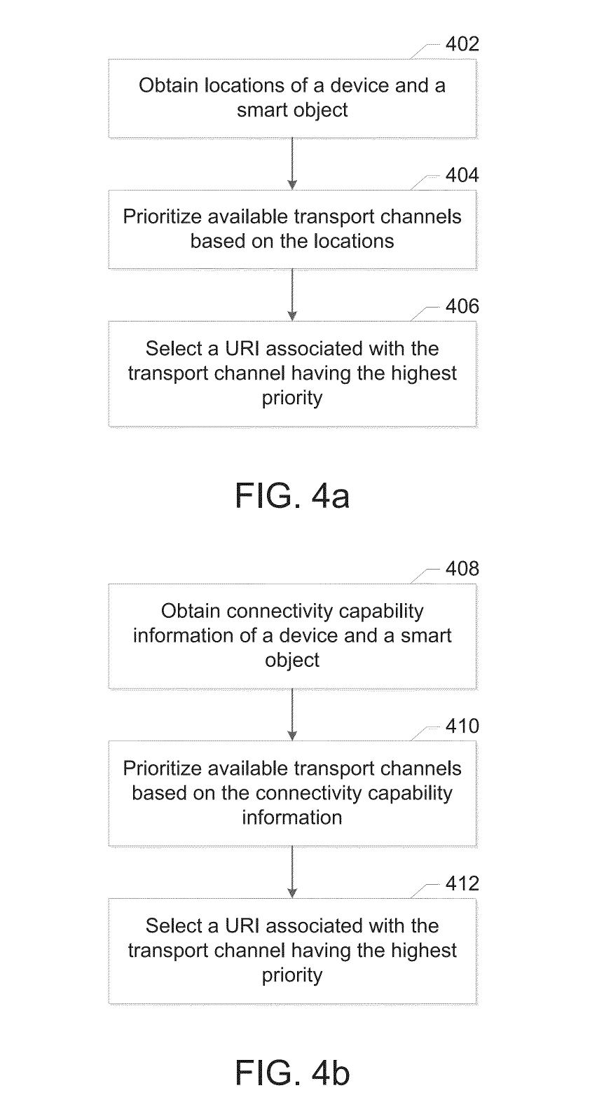

Returning to FIG. 2, in operation 208, the apparatus 100 may include means, such as processor 104 or the like, for selecting one of the URIs for communication between a device and the smart object. In some embodiments, the user is able to select a transport protocol from the set of CoAP URIs using the UI. Additionally or alternatively, selection may be based on the information received in operation 206 as is discussed in greater detail below in conjunction with FIGS. 4a and 4b.

Optionally, in operation 210, the apparatus 100 may include means, such as processor 104 or the like, for causing configuration of the smart object based on the information received in operation 206. Configuration of the smart object may include, for example, specifying a preferred URI for communication based on the URI selected in operation 208, enabling Internet connectivity of the smart object, claiming ownership of the smart object, storing a representative image for identifying the smart object (such as a photo), setting access privileges of the smart object, or any number of additional modifications that may be specific to the smart object (e.g., if the smart object is a thermostat, configuring temperature settings, etc.).

After the configuration of a smart object, the apparatus 100 may include means, such as processor 104, communications interface 106, or the like, for transmitting additional CoAP URIs associated with the smart object to the server (e.g., configuring Internet connectivity of the smart object may include adding CoAP URIs with newly available transport options). In some embodiments, this operation may be performed by the smart object itself).

Turning now to FIG. 3a, a flowchart is shown that describes example embodiments for retrieving an identifier associated with a smart object at an identified location. In operation 302, the apparatus 100 may include means, such as the user interface 102, processor 104, communications interface 106, or the like, for receiving information identifying a location to scan for smart objects. To retrieve this location information, the apparatus 100 may query one or more location (map) servers via a local network, an Internet connection, or using SMS, for example. The location servers can provide, for example, a geolocation where smart objects are likely to be detected by the apparatus 100. The location server may store this information as a result of prior registration of smart objects such as may have occurred, for example, upon purchase of the smart objects from a retailer or some other such triggering event. In embodiments in which the apparatus 100 is a mobile device, the apparatus 100 may be able to guide a user to the received geolocation (with rough accuracy or with high accuracy if high accuracy indoor/outdoor positioning services are available).

In operation 304, the apparatus 100 may include means, such as the processor 104, communications interface 106, or the like, for scanning for an identifier associated with a smart object at the identified location. In this regard, scanning at the identified location may be performed in the fashion described previously in connection with operation 202. Based on the scan, in operation 306 the apparatus 100 may include means, such as the processor 104, communications interface 106, or the like, for retrieving an identifier associated with a smart object at the identified location.

FIG. 3b illustrates a flowchart describing example operations for using a specific scanning method to retrieve an identifier associated with a smart object. In this regard, rather than receiving an identified location, in operation 308 the apparatus 100 may include means, such as the user interface 102, processor 104, communications interface 106, or the like, for receiving information identifying a scanning method. The scanning method received may be, for example, any of the methods previously described in connection with operation 202, such as WLAN scans (for access points, ad-hoc WLAN, Wi-Fi Direct), Bluetooth (Low-Energy) scans, IPv6-based scans on a local area networks (such as discovering device sending/listening of (multicast) CoAP resource discovery/local CoAP Resource Directory queries/multicast-DNS/UPnP/some other IP-based device discovery protocol messages to LAN), AwareNet scans, SMS-based discovery (client would send SMS asking for devices nearby), NFC tag reading, or QR or other barcode reading. Of course, in some embodiments, multiple scanning methods may be received.

As with the operations of FIG. 3a, the apparatus 100 may retrieve this information from one or more servers on a local network, using an Internet connection, or using SMS, for example. The server(s) may have information regarding relevant scanning methods as a result of prior registration of smart objects that may have occurred, for example, upon purchase of the smart objects from a retailer or some other such triggering event.

In operation 310, the apparatus 100 may include means, such as the processor 104, communications interface 106, or the like, for scanning for an identifier associated with a smart object using the identified scanning method. In this regard, scanning at the identified location may be performed in the fashion described previously in connection with operation 202. Based on the scan, in operation 312 the apparatus 100 may include means, such as the processor 104, communications interface 106, or the like, for retrieving an identifier associated with a smart object.

Turning now to FIGS. 4a and 4b, flowcharts are provided describing operations for selecting a URI by utilizing information possibly provided in conjunction with the CoAP URI list.

In FIG. 4a, a flowchart is shown that describes example operations for selecting a URI based on location information of a device and a smart object. In operation 402, the apparatus 100 may include means, such as the processor 104, communications interface 106, or the like, for obtaining locations of a device and a smart object. In this regard, the device may be the apparatus 100 itself, or may be a different device that will communicate with the smart object. The locations may comprise specific geolocations that can direct a user to a discrete place. Such information may be received in conjunction with the receipt of the one or more URIs associated with the smart object, as described in connection with operation 206 above.

Subsequently, in operation 404, the apparatus 100 may include means, such as the processor 104, or the like, for prioritizing available transport channels based on the locations. In this regard, the highest priority transport channel is associated with a local connectivity channel. Accordingly, the apparatus 100 may use the location information to determine whether a local connectivity channel is reachable. If a URI associated with an NFC connectivity channel is available, a UI presented to the user may request that the user touches the destination in order to enable use of NFC. If local connectivity is not possible based on the available list of CoAP URIs or based on the obtained location information, the channel priority is ordered using a default order of priority. In one example, the default ordering of priority may be as follows:

local connectivity channel (BT-LE, NFC, etc.);

direct UDP-based IP transport channel (if no Firewalls/network address translations (NATs) are present);

direct TCP-based IP-communication;

other direct IP-based transport protocols (SCTP/DCCP);

proxy-based UDP-channel;

proxy-based TCP-channel;

other proxy-based IP-based transport protocols (SCTP/DCCP);

websocket-based communications;

HTTP/CoAP application proxy;

SMS or other Delay Tolerant Networking based approach, such as Bundle protocol.

Subsequently, in operation 406, the apparatus 100 may include means, such as the processor 104 or the like, for selecting a URI associated with the transport channel having the highest priority.

Turning now to FIG. 4b, a flowchart is illustrated that describes example operations selecting a URI based on connectivity capability information of a device and a smart object. In operation 408, the apparatus 100 may include means, such as the processor 104, communications interface 106, or the like, for obtaining connectivity capability information about a device and a smart object. In this regard, the device may be the apparatus 100 itself, or may be a different device that the user expects will communicate with the smart object. The information may include connectivity means available (e.g. whether client and/or smart object currently has Internet connectivity (some roaming devices might not have Internet connectivity, and the smart object may not yet be configured with appropriate Internet connectivity settings)), whether Internet connectivity is IPv4, IPv6, both, and/or if there are Firewalls and NATs present, which can be obtained by well-known connectivity tests. Such information may be received in conjunction with the receipt of the one or more URIs associated with the smart object, as described in connection with operation 206 above.

Subsequently, in operation 410, the apparatus 100 may include means, such as the processor 104, or the like, for prioritizing available transport channels based on the connectivity capability information. In this regard, the highest priority transport channel is associated with a local connectivity channel. Accordingly, the apparatus 100 may use the connectivity capability information to determine whether the device and the smart object enable communication using a local connectivity channel. If a URI associated with an NFC connectivity channel is available and the device is able to communicate using an NFC channel, a UI presented to the user may request that the user touches the destination in order to enable use of NFC. If local connectivity is not possible based on the available list of CoAP URIs or based on the obtained connectivity capability information, the channel priority is ordered by default, as described previously in connection with FIG. 4a.

Subsequently, in operation 412, the apparatus 100 may include means, such as the processor 104 or the like, for selecting a URI associated with the transport channel having the highest priority.

In some embodiments, the apparatus 100 may use both location information and connectivity capability information to select an appropriate URI. Additionally or alternatively, the user, having the benefit of the location and/or connectivity capability information, may manually select the URI, or may specify a preferred default order of priority of transport channels that the apparatus 100 may use to prioritize and select URIs.

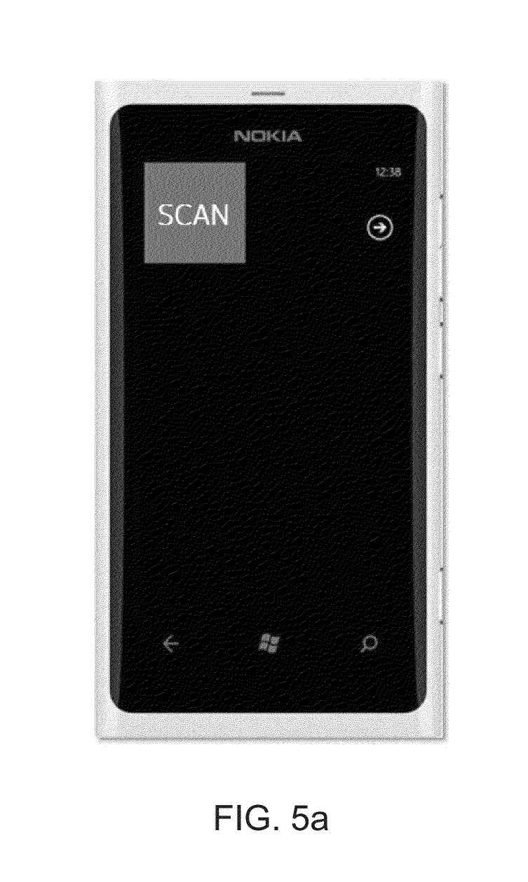

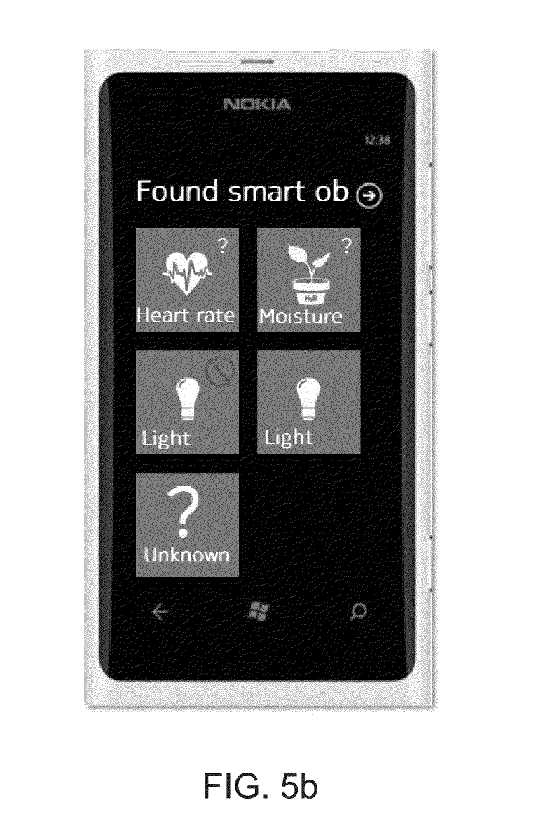

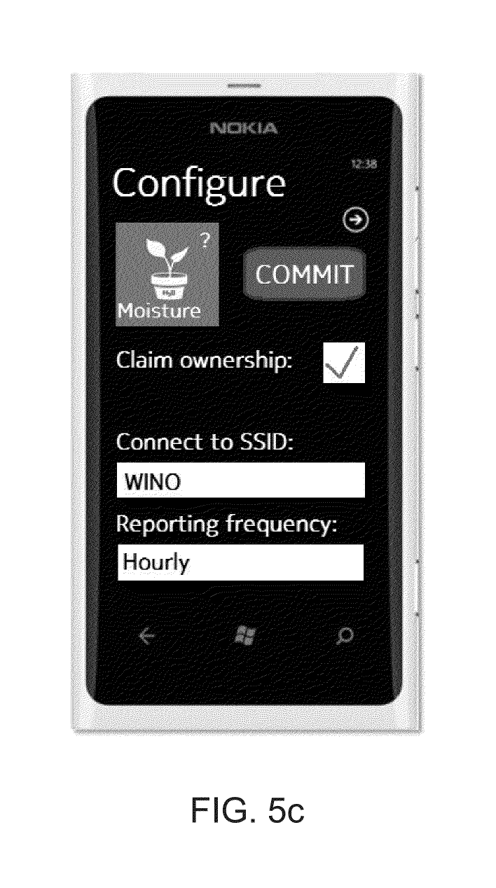

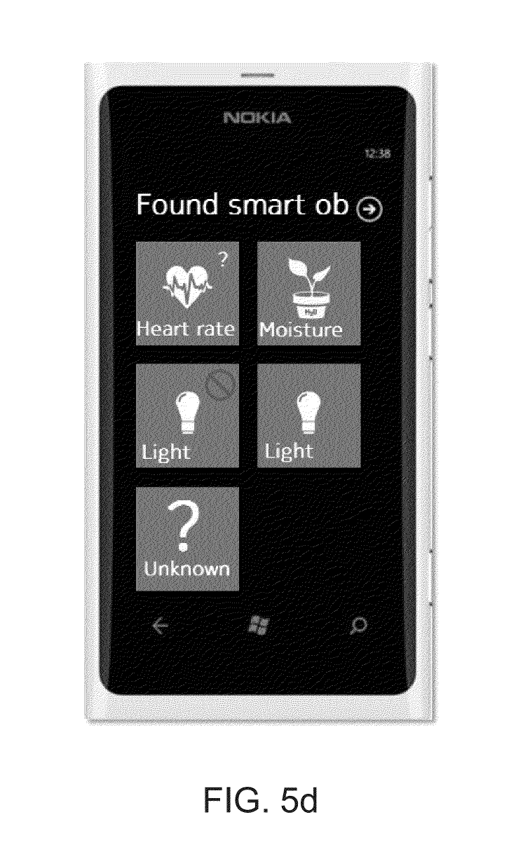

Turning now to FIGS. 5a through 5d, user interfaces are shown associated with a possible user experience for communicating and configuring smart objects enabled by the present invention. As noted previously, the apparatus 100 may display a UI to a user. In embodiments in which the previously scanning operation is a manual action, the user may click the SCAN button shown in the FIG. 5a. Of course, scanning could be automatic, periodic, or triggered by some action such as user lifting the phone. After the apparatus 100 has scanned through relevant available WLAN access points, BT network, IP hosts in the attached WLAN network, and so forth to collect list of found smart objects, the apparatus 100 may include means, such as the processor 104, communications interface 106, or the like, for sending the list to a server (which may be local, nonlocal, or cloud-based). In some implementations, queries to the server could be made immediately upon finding a smart object, so that the UI “fills up” quicker and the user does not have to wait for an entire scan to complete before being able to do something.

The apparatus 100 may include means, such as the user interface 102 or the like, for dynamically updating the UI to show the results of the scan (the found smart objects, but not necessarily showing all details such as what transport channels are supported for each smart object) to the user, as shown in FIG. 5b. This example list shows one heart rate monitor, one plant moisture meter, two lights, and one partially recognized smart object. In this example, many more smart objects may have been found in the scan, but were not recognized by the server as communicable smart objects, and accordingly are not shown on this list. The icons may be received from the server as previously described, or generic icons may be shown for well-known smart object types, such as a thermometer. It is also possible that some of the smart objects are reachable with IP, and therefore that the apparatus 100 may have fetched information about them itself (e.g., using a CoAP GET function).

FIG. 5b shows that for one of the found smart objects (the left side light) the user has no access (circular symbol). In this example, this symbol indicates that the server has identified the smart object, but because it is owned by someone else, the apparatus 100 cannot access it. Furthermore, FIG. 5b shows that the apparatus 100 or the server has discovered that for one smart object (the right side light), the user already has access (and it is in use already). This fact is represented by a check mark symbol in this example. The topmost smart objects of FIG. 5b shows question marks, which in this example indicate that these two smart objects were found, but are currently under no one's control. The bottom smart object of FIG. 5b shows an unknown smart object that was found, but with which the server and the apparatus 100 are not sure how to communicate, or for which complete information (such as icons) is not available. Such smart objects might be configurable manually, or alternatively this result could indicate that a “driver” is required for communication and/or configuration of the unknown smart object.

After clicking one of the unclaimed smart objects, like the plant moisture sensor shown in FIG. 5b, the apparatus 100 may include means, such as the user interface 102 or the like, for presenting a new dynamically constructed UI view, as shown in FIG. 5c. The UI is constructed based on the configuration information known to be available on the smart object. In this UI, the user can select what information needs to be pushed to the sensor. Using this UI, ownership of the smart object can be claimed, information about how the smart object can connect to the Internet can be entered (using, for example WLAN SSID and credentials), and a frequency can be set instructing the smart object regarding how often it should transmit measurement reports. Of course, FIG. 5c represents an example only and in other embodiments this UI may indicate any number of other configurable settings. As shown in FIG. 5c, the user in this case has claimed the smart object, set an SSID for Internet access, and set a reporting frequency. After pressing the ‘COMMIT’ button, the apparatus 100 uses the transport protocol, respective channel (UDP/TCP/SMS/etc) and semantic information received from the server to push the settings to the smart object. In this case, the settings include ownership information, WLAN SSID and credentials (not shown) the smart object needs to use to connect to Internet (user IDs, passwords, etc.), and then the reporting period.

After committing the changes, the apparatus 100 may include means, such as the user interface 102 or the like, for presenting a UI having an updated scan menu that shows this smart object as owned (as shown in FIG. 5d). The apparatus 100 may then the apparatus 100 may include means, such as processor 104, communications interface 106, or the like, for report the changes (e.g. ownership claim, etc.) to the server.

Although the use case of a moisture sensor is discussed above, another potential use case is a wireless charger, or a free wireless charging station, that is a smart object. Through communication and configuration as disclosed above, the charger could limit who can charge from it, the owner could allow the charger to charge friends' phones, the ownership of charger could be claimed, and statistics on who has used the charger could be collected.

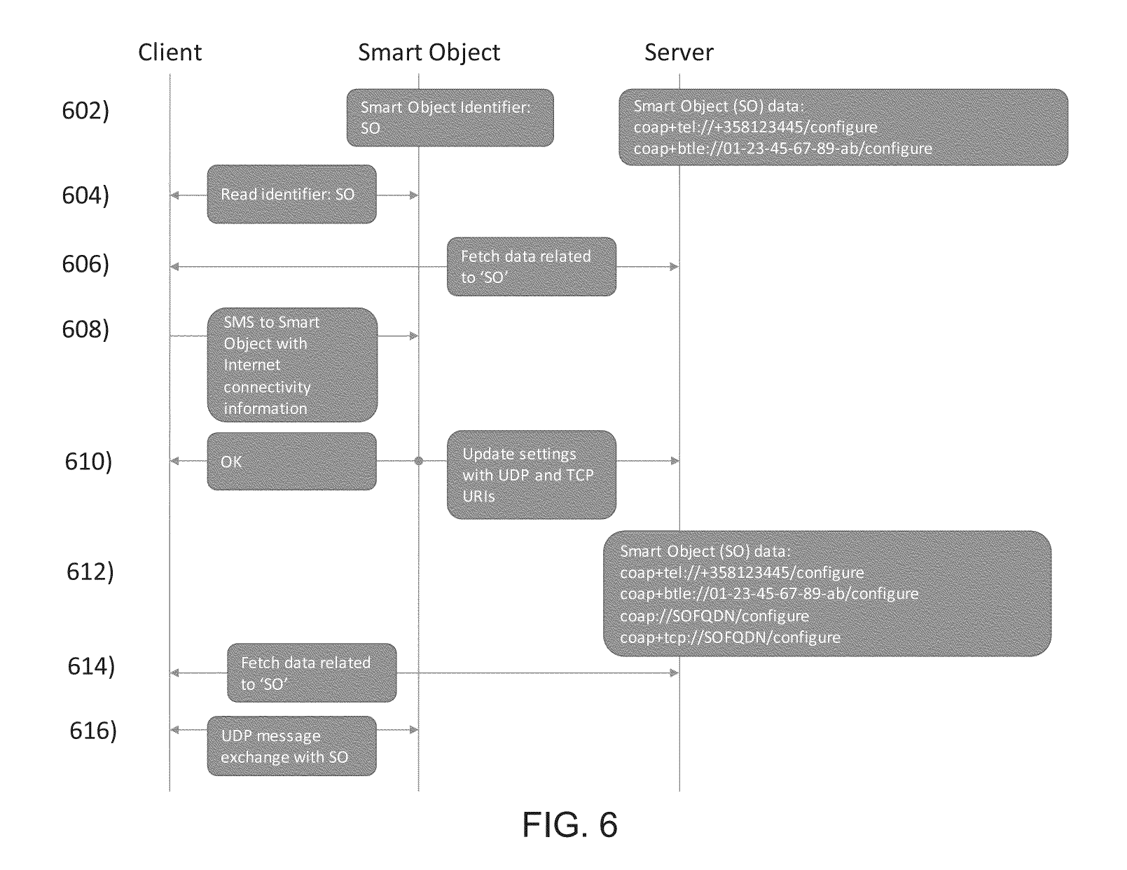

Turning now to FIG. 6, an example message exchange is illustrated showing how a client, such as apparatus 100 or the like, learns relevant CoAP URIs and uses them with the help of a server, in accordance with embodiments described above. As shown on line 602, a smart object is associated with an identifier “SO,” and a server stores preconfigured CoAP URIs (e.g., vendor provisioned by management tools) for the smart object. On line 604, the client finds the smart object's identifier. On line 606, the client queries the server for CoAP URIs associated with the smart object. On line 608, the client sends a message to the smart object (in this case, using an SMS, because the distance is not close enough to use local connectivity capabilities), and configures Smart Object with Internet connectivity settings (and possibly claims ownership). If the client were closer to the smart object, the configuration settings could be pushed using BT-LE.

As shown on line 610, the smart object acknowledges configuration and adds new CoAP URIs to the server. Here, the smart object uses an active display to show QR-codes, which can later be updated to display new URIs. As shown on line 612, the server thus stores additional information about the smart object. Thereafter, as shown on line 614, the client fetches updated information about the smart object, and on line 616, the client is able to communicate directly with the smart object using UDP over the Internet (rather than the slower SMS, used previously).

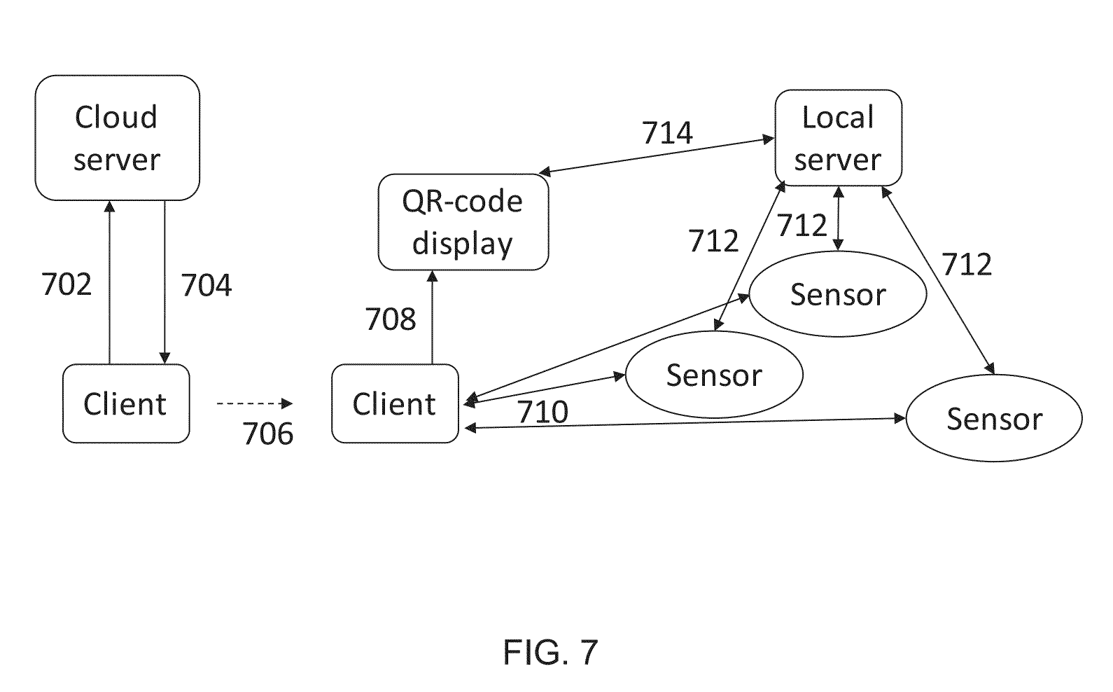

Turning now to FIG. 7, another embodiment is illustrated in which a client, such as apparatus 100, obtains information about the location of one or more smart objects from an Internet-connected server, but is only able to obtain more detailed smart object information upon reaching the identified location. In this manner, the security of the smart objects can be more easily maintained by ensuring that only physically nearby devices are able to access the smart object information.

In operation 702, the apparatus 100 may include means, such as the processor 104, communications interface 106, or the like, for requesting information from a server (e.g., a location server, or other “cloud” server) about a place and/or method to search for smart objects. In operation 704, the apparatus 100 may include means, such as the processor 104 or the like, for receiving, from the server, a geolocation and/or method for scanning for information (as previously discussed in connection with FIGS. 3a and 3b). In this example, the server may send information directing the apparatus 100 to a location to read a QR-code.

In operation 706, the user takes the apparatus 100 to the location indicated by the server. Subsequently, in operation 708, the apparatus 100 may include means, such as the processor 104, communications interface 106, or the like, for scanning a QR code (from an active or passive display) and obtaining a list of CoAP URIs. The list of CoAP URIs points to local sensors (designated in FIG. 7 as “sensor”). This list can use URIs associated with various transport channels, such as Bluetooth Low Energy, WiFi, SMS, etc., as previously described. In operation 710, apparatus 100 may include means, such as the processor 104, communications interface 106, or the like, for selecting an appropriate channel and communicating with the sensors. During communication, the apparatus 100 may update the sensors' connectivity capabilities as previously described in conjunction with FIG. 6.

In operation 712, the sensors update the local server with their reachability methods (e.g., newly assigned URIs) using, for example, CoAP and whatever transport channel exists between themselves and the local server. Finally, in operation 714, the local server updates the QR code active display with the new URI information. Of course, the scenario can proceed in an alternative order, for example, where the apparatus 100 first configures the sensors (operation 710), the sensors update their location to server (operation 712), and the QR code active display only thereafter becomes visible for other devices to find. As noted previously, this embodiment enables heightened security of the smart objects, because FIG. 7 describes an embodiment having a local server that does not necessarily have external Internet connectivity store URIs associated with the smart objects.

As described above, certain example embodiments of the present invention enable communication and configuration of smart objects, enabling selection of the best transport channels for accessing, configuring, and communicating with smart objects.

FIGS. 2-4b, 6, and 7 illustrate operations of an apparatus, method, and computer program product according to example embodiments of the invention. It will be understood that each block of the flowcharts, combinations of blocks in the flowcharts, and other described operations may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 108 of an apparatus employing an embodiment of the present invention and executed by a processor 104 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks and other described operations.

Accordingly, blocks of the flowcharts support combinations of means for performing the specified functions and combinations of operations for performing the specified functions. It will also be understood that one or more blocks of the flowcharts, combinations of blocks in the flowcharts, and other described operations can be implemented by special purpose hardware-based computer systems which preform the specified functions, or combinations of special purpose hardware and computer instructions.

In some embodiments, certain ones of the operations above may be modified or further amplified. Furthermore, in some embodiments, additional optional operations may be included. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
retrieving an identifier associated with a smart object;
causing transmission of the identifier;
receiving, based on the identifier, one or more universal resource identifiers (URIs) associated with the smart object; and
selecting, by a processor, one of the URIs for communication between a device and the smart object.

2. The method of claim 1, further comprising:
scanning for the identifier using at least one method selected from a group consisting of WLAN scanning, Bluetooth scanning, Internet Protocol version 4 (IPv4)-based scanning, Internet Protocol version 6 (IPv6)-based scanning, AwareNet scanning, Short Message Service (SMS)-based discovery, Near-Field Communication (NFC) tag reading, Quick Response (QR) code reading, or barcode reading,
wherein the identifier is retrieved in response to the scan.

3. The method of claim 2, further comprising:
receiving information identifying a location or scanning method,
wherein scanning for the identifier is performed at the identified location or using the identified scanning method.

4. The method of claim 2, wherein scanning for the identifier is performed automatically.

5. The method of claim 2, wherein scanning for the identifier is performed in response to user input.

6. The method of claim 1, further comprising:
obtaining additional information about the device and the smart object, the information comprising locations of the device and the smart object or connectivity capabilities of the device and the smart object; and
prioritizing transport channels associated with the URIs based on the additional information,
wherein the selected URI comprises the URI associated with the transport channel having the highest priority.

7. The method of claim 1, further comprising causing configuration of the smart object based on the selected URI.

8. An apparatus comprising at least one processor and at least one memory including computer program code, the at least one memory and the computer program code configured to, with the at least one processor, cause the apparatus to:
retrieve an identifier associated with a smart object;
cause transmission of the identifier;
receive, based on the identifier, one or more universal resource identifiers (URIs) associated with the smart object; and
select one of the URIs for communication between a device and the smart object.

9. The apparatus of claim 8, wherein the at least one memory and the computer program code are further configured to, with the at least one processor, cause the apparatus to:
scan for the identifier using at least one method selected from a group consisting of WLAN scanning, Bluetooth scanning, Internet Protocol version 4 (IPv4)-based scanning, Internet Protocol version 6 (IPv6)-based scanning, AwareNet scanning, Short Message Service (SMS)-based discovery, Near-Field Communication (NFC) tag reading, Quick Response (QR) code reading, or barcode reading,
wherein the identifier is retrieved in response to the scan.

10. The apparatus of claim 9, wherein the at least one memory and the computer program code are further configured to, with the at least one processor, cause the apparatus to:
receive information identifying a location or scanning method,
wherein scanning for the identifier is performed at the identified location or using the identified scanning method.

11. The apparatus of claim 9, wherein scanning for the identifier is performed automatically.

12. The apparatus of claim 9, wherein scanning for the identifier is performed in response to user input.

13. The apparatus of claim 8, wherein the at least one memory and the computer program code are further configured to, with the at least one processor, cause the apparatus to:
obtain additional information about the device and the smart object, the information comprising locations of the device and the smart object or connectivity capabilities of the device and the smart object; and
prioritize transport channels associated with the URIs based on the additional information,
wherein the selected URI comprises the URI associated with the transport channel having the highest priority.

14. The apparatus of claim 8, wherein the at least one memory and the computer program code are further configured to, with the at least one processor, cause the apparatus to cause configuration of the smart object based on the selected URI.

15. The apparatus of claim 8 is comprised in the device.

16. A computer program product comprising at least one non-transitory computer-readable storage medium having computer-executable program code portions stored therein, the computer-executable program code portions comprising program code instructions that, when executed, cause an apparatus to:
retrieve an identifier associated with a smart object;
cause transmission of the identifier;
receive, based on the identifier, one or more universal resource identifiers (URIs) associated with the smart object; and
select one of the URIs for communication between a device and the smart object.

17. The computer program product of claim 16, wherein the program code instructions, when executed, further cause the apparatus to:
scan for the identifier using at least one method selected from the group consisting of WLAN scanning, Bluetooth scanning, Internet Protocol version 4 (IPv4)-based scanning, Internet Protocol version 6 (IPv6)-based scanning, AwareNet scanning, Short Message Service (SMS)-based discovery, Near-Field Communication (NFC) tag reading, Quick Response (QR) code reading, or barcode reading,
wherein the identifier is retrieved in response to the scan.

18. The computer program product of claim 17, wherein the program code instructions, when executed, further cause the apparatus to:
receive information identifying a location or scanning method,
wherein scanning for the identifier is performed at the identified location or using the identified scanning method.

19. The computer program product of claim 17, wherein scanning for the identifier is performed in response to user input.

20. The computer program product of claim 16, wherein the program code instructions, when executed, further cause the apparatus to:
obtain additional information about the device and the smart object, the information comprising locations of the device and the smart object or connectivity capabilities of the device and the smart object; and
prioritize transport channels associated with the URIs based on the additional information,
wherein the selected URI comprises the URI associated with the transport channel having the highest priority.
